(19) United States
(12) Patent Application Publication
(10) Pub. No.: US 2013/0163971 A1
(43) Pub. Date: Jun. 27, 2013

(54) ELECTRIC HEATING DEVICE

(71) Applicant: BorgWarner BERU Systems GmbH, Ludwigsburg (DE)

(72) Inventors: Michael Luppold, Dettenheim (DE); Alexander Dauth, Maulbronn (DE); Juergen Kochems, Illingen (DE)

(73) Assignee: BorgWarner BERU Systems GmbH, Ludwigsburg (DE)

(21) Appl. No.: 13/720,490

(22) Filed: Dec. 19, 2012

(30) Foreign Application Priority Data
Dec. 22, 2011 (DE) 10 2011 056 930.8

(51) Int. Cl. B60H 1/22

(52) U.S. Cl. 392/487; 392/485

(57) ABSTRACT

The invention relates to an electric heating device for a motor vehicle, said electric heating device comprising a ceramic heating resistor and a metal cooling body, which has two mutually opposed primary sides, wherein one of the two primary sides forms an inflow side, against which a fluid stream to be heated flows. In accordance with this disclosure, the heating resistor is arranged in a groove, which is located in one of the two primary sides of the cooling body.

### RELATED APPLICATIONS

This application claims priority to DE 10 2011 056 930.8, filed Dec. 22, 2011 which is hereby incorporated by reference in its entirety.

### BACKGROUND

The invention relates to an electric heating device comprising a ceramic heating element and metal cooling body, which has two mutually opposed primary sides. During operation, a fluid to be heated flows onto one of the two primary sides. The two primary sides of a cooling body are often also referred to as the front side and rear side.

A heating device is known from US 2009/0139983 A1, in which an extruded profile forms a cooling body and, at the same time, also forms a tubular housing in which ceramic PTC heating elements are arranged. The extruded profile has openings transverse to the direction of extrusion, and an air stream to be heated flows through the openings.

Heating devices in which heating elements are arranged between extruded profiles, at which an air stream to be heated flows along in the direction of extrusion, are also known, for example from EP 1 370 117 A2 and EP 1 731 852 A1.

### SUMMARY

The present invention presents a way in which a heating device for heating the interior of a motor vehicle can be manufactured in a simple manner.

In a heating device according to this disclosure, the heating resistor is arranged in a groove that is located in one of the two primary sides of the cooling body.

Heating resistors can be inserted easily into the groove and are almost as well protected therein as in the tubular housing of an extruded profile. The complexity of the manufacturing process for a heating device according to this disclosure is advantageously much lower, however, compared to that for the heating device known from US 2009/0139983 A1, the latter of which requiring additional manufacturing steps to form openings, transverse to the direction of extrusion, in the extruded profile used as a housing. With a heating device according to this disclosure, it is possible to dispense with manufacturing steps of this kind since the cooling body of a heating device according to this disclosure can be cast directly in the required form, inclusive of the groove. A heating device according to this disclosure can therefore be produced with advantageously few manufacturing steps.

A further advantage of a heating device according to this disclosure lies in the fact that only a relatively small number of individual parts are required. The assembly is therefore much simpler than with the heating devices known from EP 1 370 117 A2 or EP 1 731 852 A1, in which PTC heating elements have to be arranged and held between individual cooling bodies.

Since the groove is located in one of the two primary sides of the cooling body, an air stream to be heated can flow against it; that is to say said groove can be arranged in a front side or inflow side of the cooling body. However, the heating device may also be used so that the groove is not arranged in the inflow side, but in the opposed primary side of the cooling body.

In accordance with an advantageous refinement of this disclosure, the heating resistor's contact sides face toward the side walls of the groove. The contact sides are the sides of the heating resistor at which it is electrically contacted. For assembly, the heating resistors can be fitted into the groove beforehand via a narrow side. The risk of breakage during assembly can thus be reduced. In addition, heat generated by the heating resistors can be discharged via an advantageously large contact area with the cooling body.

In accordance with a further refinement of this disclosure, the cooling body carries a fastening flange, which extends transverse to the groove. For example, the heating device can be fastened in an air duct of a motor vehicle by means of such a fastening flange and can thus advantageously be used to heat the interior of a motor vehicle. The fastening flange can be formed in one piece with the cooling body, e.g., an integrally formed or unitary structure. The fastening flange may also be formed as a separate component, however, which is fastened to the cooling body.

The fastening flange may form a plug, with which the heating device can be connected to an electric power source. The plug may have one or more contact tongues, which are formed by a metal contact sheet, which contacts a heating resistor or a plurality of heating resistors. Such a metal contact sheet protrudes from the groove at one end.

In accordance with a further advantageous refinement of this disclosure, the groove is filled with casting compound. A good level of protection, for example IP 40 or better, can thus be achieved with little effort. The electrically insulating casting compound may cover the heating resistor in the groove and/or metal contact sheets resting against the heating resistor.

Insofar as an indefinite article is used in the claims, this is not to be understood as a numeral, but is to be read to mean “at least one.” For example, a heating device according to the invention may have a plurality of heating resistors, in particular PTC resistors. The heating resistors can be arranged in a single groove or distributed in a plurality of grooves. Should a plurality of grooves be provided, these may all be arranged in the same primary side of the cooling body. It is also possible, however, for one or more grooves to be located in each of the two primary sides of the cooling body, each of said grooves containing one or more ceramic heating resistors.

### BRIEF DESCRIPTION OF THE DRAWINGS

Further details and advantages of this disclosure will be explained on the basis of an embodiment with reference to the accompanying drawings, in which:

FIG. 1 shows a schematic illustration of a heating device;

FIG. 2 shows a sectional view along the line of section BB of FIG. 1;

FIG. 3 shows a sectional view along the line of section AA of FIG. 1.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

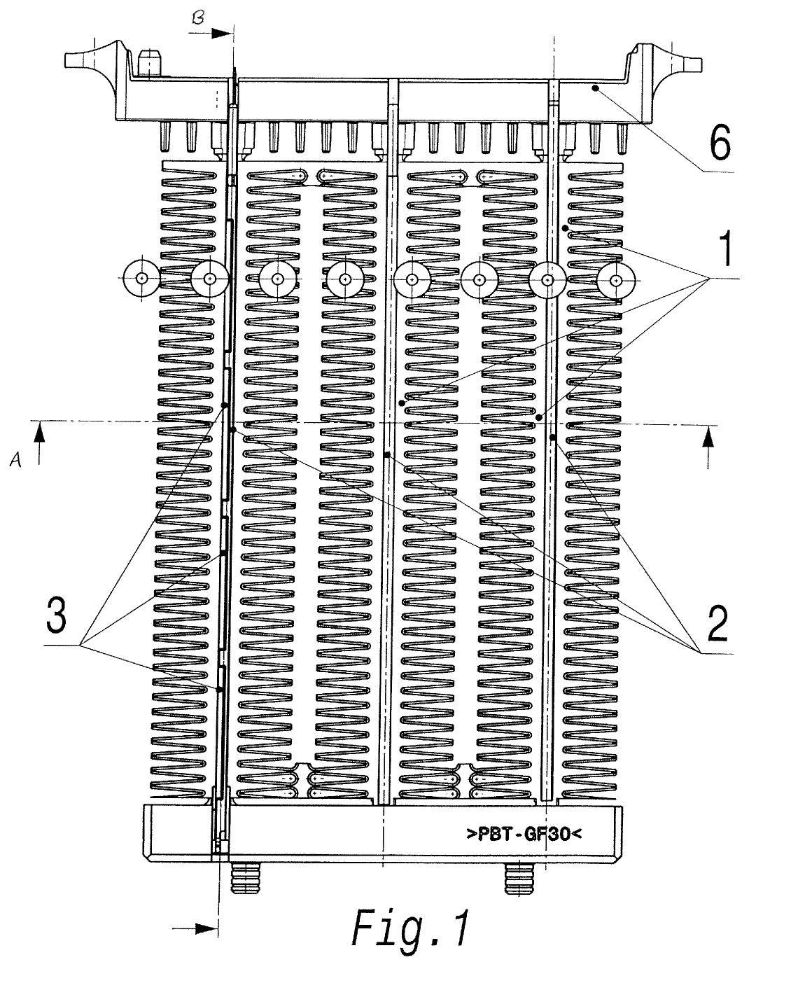

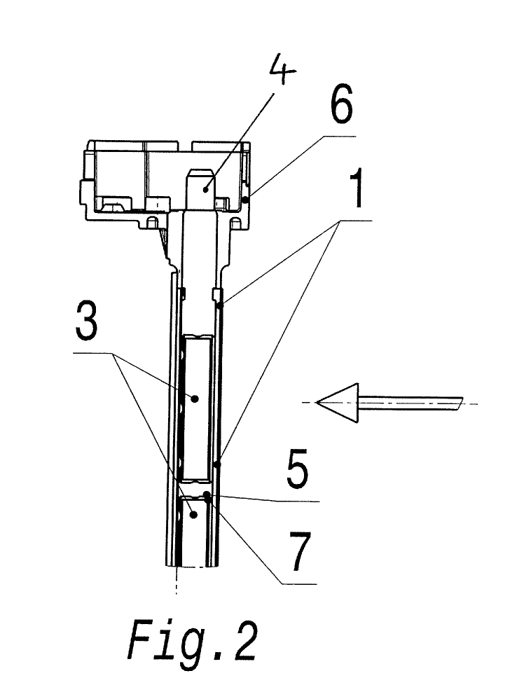

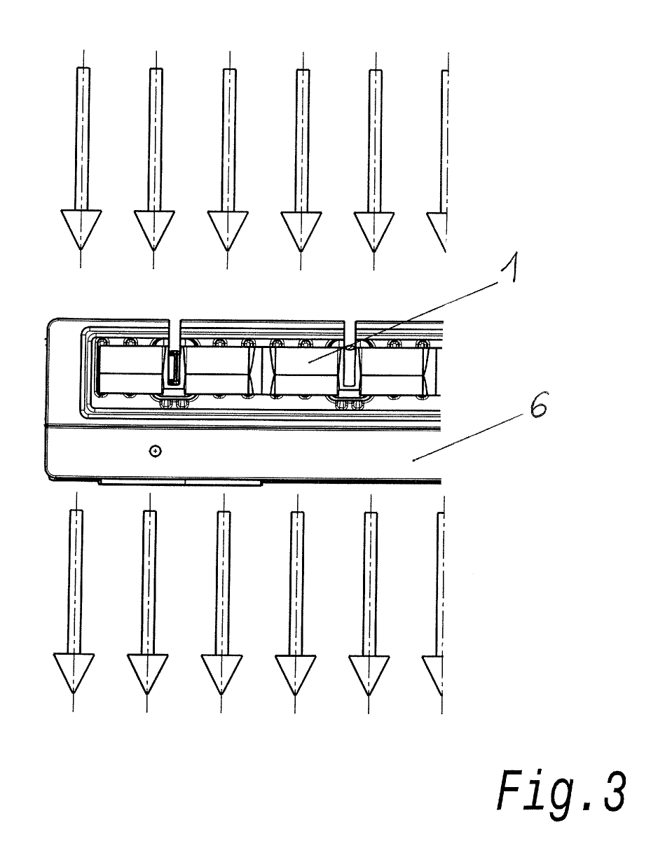

The heating device illustrated in FIGS. 1 to 3 has a cooling body 1 made of metal, which may be formed in a plate-shaped manner. In this context, “plate-shaped” is to be understood to mean that the dimension of the cooling body 1 in the direction of flow of the fluid stream to be heated, that is to say the thickness of the cooling body is small compared to the dimensions of the cooling body in the two spatial directions perpendicular to the direction of flow. In other words, the thickness of the cooling body is small compared to its length and width. The thickness of the cooling body 1, that is to say the distance between its two primary sides, is preferably less than a quarter, in particular less than a fifth, more preferably less than an eighth, of its length and its width. The direction of flow of the fluid stream is illustrated by arrows in FIGS. 2 and 3.

During operation, one of the two primary sides of the cooling body 1 faces toward an air stream to be heated and thus forms an inflow side of the cooling body 1. During operation, the opposed primary side of the cooling body 1, which may also be referred to as the rear side, thus faces away from the air stream to be heated.

A groove 2 is located in at least one of the two primary sides of the cooling body 1. In groove 2 at least one ceramic heating resistor 3, e.g., a PTC element, for example is arranged. The PTC element may for example be based on barium titanate. The contact sides of the heating resistor 3 face toward the side walls of the groove 2. The heating resistor 3 is electrically contacted at its contact sides. A narrow side of the heating resistor thus faces the base of the groove 2. The cooling body 1 may have a plurality of grooves 2, in each of which at least one ceramic heating resistor 3, possibly a plurality of ceramic heating resistors 3, are arranged.

Each heating resistor 3 has two contact sides at which it is electrically contacted. In the embodiment illustrated, the heating resistor 3 is contacted on one side by a metal contact sheet 4, which is electrically insulated with respect to the cooling body 1, for example by an insulation layer 5 made of plastics or ceramics, like aluminium oxide. The other contact side of the heating resistor 3 can be contacted by the cooling body 1 so as to form a ground contact. It is also possible, however, for the heating resistor 3 to be contacted on both contact sides by a metal contact sheet 4, which is electrically insulated with respect to the metal cooling body 1. The metal contact sheet(s) 4 is/are clamped together with the heating resistor(s) 3 into the groove 2 in the cooling body 1 and protrude with one end from the groove.

The cooling body may carry a fastening flange 6, which extends transverse to the groove 2. The fastening flange 6 may be formed in one piece with the cooling body 1 so as to reduce the number of individual parts further still. It is also possible, however, for the flange 6 to be formed as a separate part, which is fitted onto a narrow side of the cooling body 1. The metal contact sheet(s) 4 can protrude from the end of the groove 2 at which the fastening flange 6 is arranged. As fastening elements, the fastening flange 6 may have holes for screws, for example, or hooks for fastening the heating device in an air conditioning duct of a motor vehicle.

The groove 2 can be filled with casting or potting compound 7 so as to protect the heating resistor 3 arranged in the groove 2 against harmful environmental influences and/or so as to improve the electrical insulation. The electrically insulating casting compound 7 covers the heating resistors 3 and typically also the metal contact sheets 4, namely the narrow side thereof facing away from the groove base.

The heating resistors 3, metal contact sheet 4 and insulation layer 5 can be held by a plastics frame (not illustrated) to form a preassembled module. For assembly of the heating device, the preassembled module can then be introduced into a groove 2 of the cooling body 1, inclusive of the plastics frame.

The cooling body 1 may have cooling ribs. The cooling ribs extend from a side wall of the groove. In this case, cooling ribs preferably extend from both side walls of the groove.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCE NUMBERS

1 cooling body
2 groove
3 heating resistor
4 metal contact sheet
5 insulation layer
6 fastening flange
7 casting compound

1-10. (canceled)

11. An electric heating device for a motor vehicle, comprising:
a ceramic heating resistor; and
a metal cooling body having two opposed primary sides, one of the two primary sides forming an inflow side against which a fluid stream to be heated flows;
wherein the heating resistor is arranged in a groove located in one of the two primary sides of the cooling body.

12. The heating device according to claim 11, wherein the heating resistor has contact sides at which it is electrically contacted, said contact sides facing toward the side walls of the groove.

13. The heating device according to claim 11, wherein the groove is filled with casting compound.

14. The heating device according to claim 11, wherein the heating resistor in the groove rests against a metal contact sheet, which protrudes at one end from the groove.

15. The heating device according to claim 11, wherein the cooling body carries a fastening flange, which extends transverse to the groove.

16. The heating device according to claim 15, wherein the fastening flange is formed in one piece with the cooling body.

17. The heating device according to claim 11, wherein the cooling body has a plurality of grooves, in each of which at least one heating resistor is arranged.

18. The heating device according to claim 11, wherein the cooling body has cooling ribs.

19. The heating device according to claim 18, wherein cooling ribs extend from both side walls of the groove.

20. The heating device according to claim 11, wherein the cooling body is plate-shaped.
